(19) United States
(12) Patent Application Publication
(10) Pub. No.: US 2025/0352426 A1
(43) Pub. Date: Nov. 20, 2025

(54) PHYSICAL THERAPY APPLIANCE

(71) Applicant: ODECO LTD., Shenzhen, Guangdong (CN)

(72) Inventor: Huiming ZHONG, Shenzhen, Guangdong (CN)

(21) Appl. No.: 18/263,323

(22) PCT Filed: Jan. 16, 2023
(86) PCT No.: PCT/CN2023/072369

§ 371 Date: Nov. 19, 2024

(30) Foreign Application Priority Data
Jan. 27, 2022 (CN) 202210104181.7

(51) Int. Cl. A61H 19/00; A61H 23/02

(52) U.S. Cl. CPC A61H 19/32; A61H 23/02; A61H 2201/01; A61H 2201/0221; A61H 2201/5071; A61H 2201/5082; A61H 2205/087

(57) ABSTRACT

A physical therapy appliance includes a shell wherein inside the shell is provided an accommodating cavity; a soft colloid wherein the soft colloid is provided a massage channel, and at an end portion of the soft colloid is provided an opening of the massage channel; pressure expansion portions wherein the pressure expansion portions are provided on the soft colloid; and a pressure generating mechanism configured to adjust pressure of the pressure expansion portions. Expansion of pressure expansion portions enables the massage channel of the soft collide to extrude, thereby working out a penis and getting an erection last longer; the pressure generating mechanism adjusts pressure of the pressure expansion portions, so as to freely control pressure of the soft colloid, and enable the massage channel of the soft collide to exert different extruding forces, so the massage channel of the soft collide can be adapted to different specifications of penises.

### TECHNICAL FIELD

The present invention relates to the technical field of physiotherapy devices, in particular to a physical therapy appliance.

### BACKGROUND TECHNOLOGY

With the development and progress of the society, physical therapy appliances have become one of daily necessities generally recognized by the public. Physical therapy appliances, as auxiliary products for adult men's health, have made positive effects in overcoming sexual obstacles and improving sexual health. In medicine, physiotherapy appliances are not only used as auxiliary treatment tools, but also widely used as sperm extractors in sperm donation work and semen detection of patients. The physiotherapy appliances of the prior art are single in functions and lack of medical and health care function such as delaying ejaculation exercise, although existing physiotherapy appliances are provided with extrusion elements or telescopically massage structures, extrusion strengths of soft colloids thereof cannot be adjusted during use, thereby making users' comfort level low.

### SUMMARY OF THE INVENTION

### Technical Problem

The present invention aims to provide a physiotherapy appliance and solve the technical problems that the existing physiotherapy appliances are single in functions, and extrusion forces of soft colloids thereof cannot be adjusted during use, and make comfort level of users low.

### Solution to Problems

### Solution

To overcome the foregoing problems, embodiments of the present invention provide: A physical therapy appliance comprises: a shell, wherein inside the shell is provided an accommodating cavity; a soft colloid, wherein the soft colloid is provided with a massage channel, and at an end portion of the soft colloid is provided an opening of the massage channel; pressure expansion portions, wherein the pressure expansion portions are provided on the soft colloid; and a pressure generating mechanism, wherein the pressure generating mechanism is provided inside the accommodating cavity or on the shell, the pressure generating mechanism is connected to the pressure expansion portions and is configured to adjust pressure of the pressure expansion portions.

Further, the pressure expansion portions are provided at an end portion of the soft colloid towards the opening of the massage channel to correspond to root portions of body parts and/or middle portions of the massage channel to correspond to middle portions of body parts and/or an end portion of the soft colloid back to the opening of the massage channel to correspond to head portions of body parts.

Further, on the soft colloid are opened expansion holes and the expansion holes are connected with the pressure generating mechanism to form the pressure expansion portions on the soft colloid; or the soft colloid is provided with mounting pipelines, and the pressure expansion portions are provided inside the mounting pipelines.

Further, on an outer surface of the soft colloid are provided grooves, and the pressure expansion portions are provided inside the grooves.

Further, the pressure expansion portions provided at the end portion of the soft colloid back to the opening of the massage channel comprise a concave body, and the concave body forms a shape of wrapping the massage channel at the end portion of the soft colloid back to the opening of the massage channel.

Further, the pressure expansion portions provided around the massage channel are configured to be arc-shaped, annular or spiral.

Further, at sides of the pressure expansion portions facing the massage channel are provided easily deformable walls, and the easily deformable walls deform when the pressure generating mechanism adjusts pressure of the pressure expansion portions, and deformation of the easily deformable walls is greater than deformation of other walls on the pressure expansion portions.

Further, the pressure expansion portions adopt a liquid as an expansion medium, the pressure generating mechanism comprises pumps, first pipelines, second pipelines, first valves and first liquid storage containers; the first pipelines communicate between the pumps and the first liquid storage containers, the second pipelines communicate between the pumps and the pressure expansion portions, the first valves are provided on the second pipelines, and the first valves are used to control opening and closing of the second pipelines.

Further, the pressure generating mechanism further comprises third pipelines and second valves, the third pipelines communicate between the pressure expansion portions and the first liquid storage containers, the second valves are provided on the third pipelines, and the second valves are used to control opening and closing of the third pipelines.

Further, at least two of the pressure expansion portions are provided, and the second pipelines, the third pipelines and the first valves and the second valves are provided corresponding to the pressure expansion portions, the pressure generating mechanism further comprises multi-way components, and the pumps communicate with the second pipelines through the multi-way components.

Further, the pressure generating mechanism further comprises fourth pipelines, fifth pipelines, third valves, fourth valves and second liquid storage containers; the fourth pipelines communicate between the first liquid storage containers and the second liquid storage containers, and the third valves are provided on the fourth pipelines, the third valves are used to control opening and closing of the fourth pipelines, the fifth pipelines communicate between the second liquid storage containers and the multi-way components, the fourth valves are provided on the fifth pipelines, and the fourth valves are used to control opening and closing of the fifth pipelines.

Further, the first liquid storage containers are volume invariant containers, and the second liquid storage containers are volume variable containers; when the second valves are closed and the pumps deliver liquid medium in the first liquid storage containers or/and the second liquid storage containers to the pressure expansion portions, a positive pressure field is formed inside and outside the pressure expansion portions; when the first valves are closed and the pumps deliver liquid medium in the pressure expansion portions to the second liquid storage containers, a negative pressure field is formed inside and outside the pressure expansion portions; and the positive pressure field and the negative pressure field are alternately convertible.

Further, the first liquid storage containers or the second liquid storage containers are provided with temperature sensors, heating and/or cooling assemblies.

Further, the pressure expansion portions adopt gas as an expansion medium, the pressure generating mechanism comprises pumps and pipelines, and the pipelines communicate between the pumps and the pressure expansion portions.

Further, the pressure generating mechanism further comprises valves, the valves are provided on the pipelines, and the valves are used to control opening and closing of the pipelines.

Further, the pressure expansion portions are provided to be at least two, the pipelines and the valves are provided corresponding to the pressure expansion portions, the pressure generating mechanism further comprises multi-way components, the valves communicate with the pipelines through the multi-way components.

Further, output end portions of the pumps are provided with pressure sensors.

Further, the soft colloid is provided with wavy folds surrounding the massage channel.

Further, the physical therapy appliance comprises a telescoping mechanism and a mounting base which are provided inside the accommodating cavity, wherein the telescoping mechanism is used to drive the soft colloid to extend and retract, the telescoping mechanism comprises a drive assembly and a mobile portion, the drive assembly is provided on the mounting base, and two end portions of the mobile portion respectively connect to the drive assembly and the soft colloid.

Further, the drive assembly comprises a motor, a connecting rod assembly and a connecting member, the connecting rod assembly is connected to an output end of the motor, two end portions of the connecting member respectively connect to the connecting rod assembly and the mobile portion; and the physical therapy appliance further comprises guide rails provided inside the accommodating cavity, and the mobile portion is provided with sliders which are slidably connected with the guide rails.

Further, the physical therapy appliance comprises an elastic member provided inside the accommodating cavity, an end of the elastic member is connected to the mobile portion, and another end of the elastic member is connected to an end of the soft colloid back to the opening of the massage channel.

Further, the physical therapy appliance further comprises a vibration mechanism provided on the soft colloid, so as to control vibration of the soft colloid.

Further, an end of the soft colloid near the massage channel is provided with a positioning ring, and the shell is provided with a ring buckle matching the positioning ring, and the positioning ring is engaged with the ring buckle; and the shell is provided with a bottom cover, the bottom cover is provided with internal threads, the shell is provided with external threads, and the bottom cover and the shell are connectible via screws.

Further, the physical therapy appliance comprises a controller, and the controller is electrically connected with the pressure generating mechanism.

Further, the shell is provided with a sub-shell, and the pressure generating mechanism is provided inside the sub-shell.

### BENEFICIAL EFFECTS OF THE INVENTION

### Beneficial Effects

Compared to the prior art, embodiments of the present invention has following beneficial effects: In the physical therapy appliance of the present invention, the drive assembly drives the mobile portion to move inside the shell, the soft colloid is then driven to extend and retract, and carry out reciprocating motions, thereby rubbing and stimulating body parts; an end of the elastic member is connected to the mobile portion, another end thereof is connected with the end of the soft colloid back to the opening of the massage channel, the end of the soft colloid back to the opening of the massage channel can move towards the mobile portion through the elastic member, so as to better adapt to different lengths of individuals; expansion of the pressure expansion portions enables the massage channel of the soft collide to perform an extrusion function, thereby working out a penis and having erection last longer; the pressure generating mechanism is connected to the pressure expansion portions to adjust pressure of the pressure expansion portions, so that pressure of the pressure expansion portions are controlled freely, the massage channel of the soft colloid can obtain different extrusion strengths so as to wrap tightly, so that the soft colloid have better friction and stimulation effect on body parts which enhances comfort of users; when the pressure expansion portions adopt a liquid as expansion medium, heating and/or cooling assemblies heat or cool the liquid to adjust temperature, and the pumps deliver heated or cooled liquid to the pressure expansion portions, further improving users' comfort; at middle portions of the massage channel of the soft colloid is provided with at least one pressure expansion portion, which can be adapted to different diameters, tightness and temperature requirements of individuals; the end of the soft colloid back to the opening of the massage channel corresponds to head portions of body parts the end of the soft colloid back to the opening of the massage channel forms a wrapping cavity, and at the end of the soft colloid back to the opening of the massage channel is provided at least a pressure expansion portion, the pressure generating mechanism is provided so that pressure of the soft colloid can be adjusted and the pressure can also be switched to be positive or negative to achieve the function of squeezing/sucking; and the physical therapy appliance also comprises vibration mechanisms provided on the soft colloid, which realizes the vibration function of the physical therapy appliance, enhances the degree of stimulation to body parts and improves the comfort of users.

### BRIEF DESCRIPTION OF THE DRAWINGS

In order to illustrate technical solutions of the present invention more clearly, a brief introduction will be made to accompanying drawings that need to be used in the description of the embodiments below. Obviously, the accompanying drawings in the following description are some embodiments of the present invention, and for those skilled in the art, other accompanying drawings can also be obtained according to these drawings without creative work.

FIG. 1 shows an internal structure of a physical therapy appliance in an embodiment of the present invention;

FIG. 2 is an explosive view of the physical therapy appliance in an embodiment of the present invention;

FIG. 3 shows structures of pressure expansion portions in an embodiment of the present invention;

FIG. 4 is a structural view of a sub-shell in an embodiment of the present invention;

FIG. 5 is a structural view of a soft colloid in an embodiment of the present invention;

FIG. 6 is a section view of the soft colloid in the embodiment of the present invention;

FIG. 7 a structural view of another soft colloid in an embodiment of the present invention;

FIG. 8 is a section view of the another soft colloid in the embodiment of the present invention;

FIG. 9 is a structural view of an easily movable wall in an embodiment of the present invention;

FIG. 10 is a structural view of a telescoping mechanism in an embodiment of the present invention;

FIG. 11 is a structural view of a concave body in an embodiment of the present invention;

FIG. 12 shows a state change of the concave body in an embodiment of the present invention;

FIG. 13 is a structural view of a pressure expansion portion adopting a liquid as expansion medium in an embodiment of the present invention;

FIG. 14 is a structural view of a pressure generating mechanism provided with at least two of the pressure expansion portions of FIG. 13;

FIG. 15 is a structural view of a pressure generating mechanism provided with a first liquid storage container and a second liquid storage container in an embodiment of the present invention;

FIG. 16 is a structural view of a pressure generating mechanism adopting gas as an expansion medium in an embodiment of the present invention; and

FIG. 17 is a structural view of a pressure generating mechanism provided with at least two of the pressure expansion portions of FIG. 16.

The markups in the drawings are indicated as follows: 1—shell; 2—soft colloid; massage channel; opening of the massage channel; mounting pipeline; groove; positioning ring; wavy fold; 3—pressure expansion portion; 31—concave body; 32—easily movable wall; 4—pressure generating mechanism; 401—pump; 402—first pipeline; 403—second pipeline; 404—first valve; 405—first liquid storage container; 406—third pipeline; 407—second valve; 408—fourth pipeline; 409—fifth pipeline; 410—third valve; 411—fourth valve; 412—second liquid storage container; 413—multi-way component; 5—telescoping mechanism; 51—motor; 52—connecting rod assembly; 53—connecting member; 54—mobile portion; 55—slider; 6—guide rail; 7—elastic member; 8—mounting base; 9—bottom cover; 10—accommodating cavity; 11—ring buckle; and 12—sub-shell.

### EMBODIMENTS OF THE INVENTION

### Specific Embodiments

Unless otherwise defined, all technical and scientific terms used herein have same meanings as commonly understood by one of ordinary skill in the technical field of the present invention. The terms used in the description of the present invention are only for the purpose of describing specific embodiments, and are not intended to limit the present invention. The terms “comprising” and “having” in the specification and claims of the present invention and the above description of the drawings, as well as any variations thereof, are intended to cover non-exclusive inclusion. The terms “first”, “second” and the like in the description and claims of the present invention or the above drawings are used to distinguish different objects, rather than to describe a specific order.

Reference herein to an “embodiment” means that a particular feature, structure, or characteristic described in connection with the embodiment can be included in at least one embodiment of the present invention. The appearances of this phrase in various places in the specification are not necessarily all referring to a same embodiment, nor are independent or alternative embodiments mutually exclusive of other embodiments. It is understood explicitly and implicitly by those skilled in the art that the embodiments described herein can be combined with other embodiments.

In order to enable those skilled in the art to better understand the technical solutions of the present invention, the following will clearly and completely describe the technical solutions in the embodiments of the present invention with reference to the relevant drawings.

### EMBODIMENTS

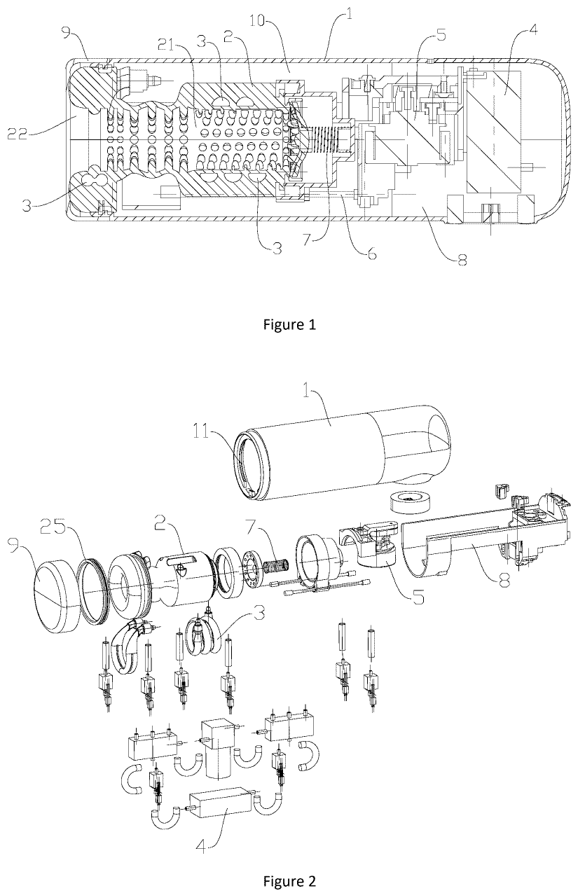

As shown in FIG. 1 and FIG. 2, a physical therapy appliance, comprises: a shell 1, wherein inside the shell 1 is provided an accommodating cavity 10; a soft colloid 2, wherein the soft colloid 2 is provided inside the accommodating cavity 10, the soft colloid 2 is provided with a massage channel, and at an end portion of the soft colloid 2 is provided an opening of the massage channel 22; pressure expansion portions 3, wherein the pressure expansion portions 3 are provided on the soft colloid 2; and a pressure generating mechanism 4, wherein the pressure generating mechanism 4 is provided inside the accommodating cavity 10 or on the shell 1, the pressure generating mechanism 4 is connected to the pressure expansion portions 3 so as to adjust pressure of the pressure expansion portions.

An embodiment of the present invention provides a physical therapy appliance that can be used as a medical instrument, wherein expansion of pressure expansion portions 3 enables the massage channel 21 of the soft collides 2 to perform an extrusion function on a penis, thereby working out the penis and getting erection last longer; the pressure generating mechanism 4 is connected to the pressure expansion portions 3, the pressure generating mechanism 4 adjusts pressure of the pressure expansion portions 3, so as to freely control pressure of the soft colloid 2, and enable the massage channel 21 of the soft collides 2 to exert different extruding forces and make a tightly wrapping effect, so that the soft colloid 2 has better friction and stimulation effect on body parts and comfort of users are enhanced.

As shown in FIG. 4, in an embodiment, the shell 1 is provided with a sub-shell 12, and the pressure generating mechanism 4 is provided inside the shell 12.

The pressure expansion portions 3 are provided at end portions of the soft colloid 2 towards the opening 22 of the massage channel to correspond to root portions of body parts and/or middle portions of the massage channel 21 to correspond to middle portions of body parts and/or end portions of the soft colloid 2 back to the opening 22 of the massage channel to correspond to head portions of body parts.

As shown in FIG. 1 and FIG. 2, end portions of the soft colloid 2 towards the opening 22 of the massage channel correspond to root portions of body parts middle portions of the massage channel 21 of the soft colloid 2 correspond to middle portions of body parts at end portions of the soft colloid facing the opening 22 of the massage channel and the middle portion of the massage channel 21 is provided at least one of the pressure expansion portions 3, so as to adapt to different diameters and tightness requirements of different individuals, end portions of the soft colloid 2 back to the opening 22 of the massage channel corresponding to head portions of body parts form a wrapping cavity, at end portions of the soft colloid 2 back to the opening 22 of the massage channel is provided at least one of the pressure expansion portions 3, pressure of the soft colloid 2 can be adjusted through the pressure generating mechanism 4, and the pressure can also be switched between positive and negative values to achieve functions of squeezing/sucking.

The pressure expansion portions 3 is provided to be at least one.

Preferably, the pressure expansion portions 3 are provided at end portions of the soft colloid 2 facing the opening 22 of the massage channel, middle portions of the massage channel 21, and end portions of the soft colloid 2 back to the opening 22 of the massage channel, the pressure expansion portions 3 is respectively provided at the end portions of the soft colloid 2 facing the opening 22 of the massage channel, the middle portions of the massage channel 21, and at the end portions of the soft colloid 2 back to the opening 22 of the massage channel.

Preferably, the pressure expansion portions 3 are provided at end portions of the soft colloid 2 facing the opening 22 of the massage channel and middle portions of the massage channel 21, and at least one of the pressure expansion portions 3 is respectively provided at the end portions of the soft colloid 2 facing the opening 22 of the massage channel and the middle portions of the massage channel 21; or, the pressure expansion portions 3 are provided at middle portions of the massage channel 21 and end portions of the soft colloid 2 back to the opening 22 of the massage channel, and at least one of the pressure expansion portions 3 is respectively provided at the middle portions of the massage channel 21 and the end portions of the soft colloid 2 back to the massage channel opening 22; or, the pressure expansion portions 3 are merely provided at end portions of the soft colloid 2 facing the opening 22 of the massage channel, or the middle portions of the massage channel 21, or end portions of the soft colloid 2 back to the opening 22 of the massage channel.

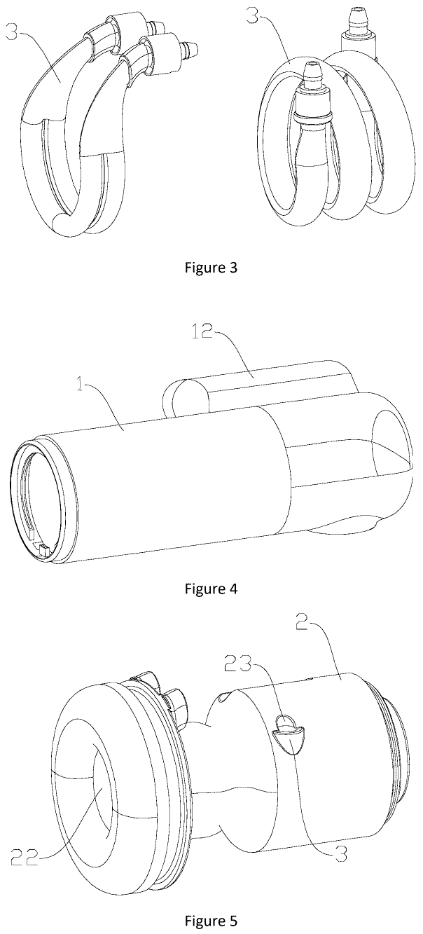

As shown in FIG. 3, the pressure expansion portions 3 are in shape of arcs, rings or spirals provided around the massage channel 21.

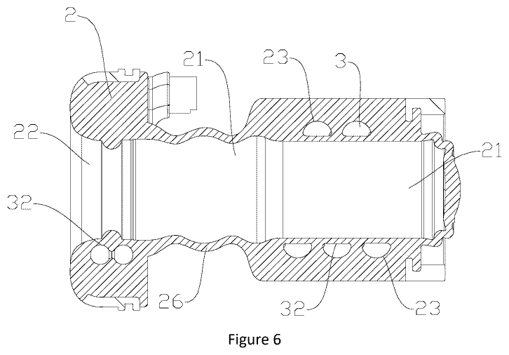

As shown in FIG. 5 and FIG. 6, in an embodiment of the present invention, the pressure expansion portions 3 are provided inside the soft colloid 2.

On the soft colloid 2 are opened expansion holes and the expansion holes are connected with the pressure generating mechanism 4 to form the pressure expansion portions 3 on the soft colloid 2;

Or the soft colloid 2 is provided with mounting pipelines 23, and the pressure expansion portions 3 are provided inside the mounting pipelines 23.

Preferably, the mounting pipelines 23 are ring-shaped mounting pipelines and correspondingly, the pressure expansion portions are in shape of rings. The mounting pipeline can also be arc or spiral mounting pipes, correspondingly the pressure expansion portions are in shape of arcs or spirals, and it can be understood that the mounting pipeline 23 can be of shapes which are adaptively set according to shapes of the pressure expansion portions 3.

Preferably, the pressure expansion portions 3 can also be integrally formed inside the soft colloid 2.

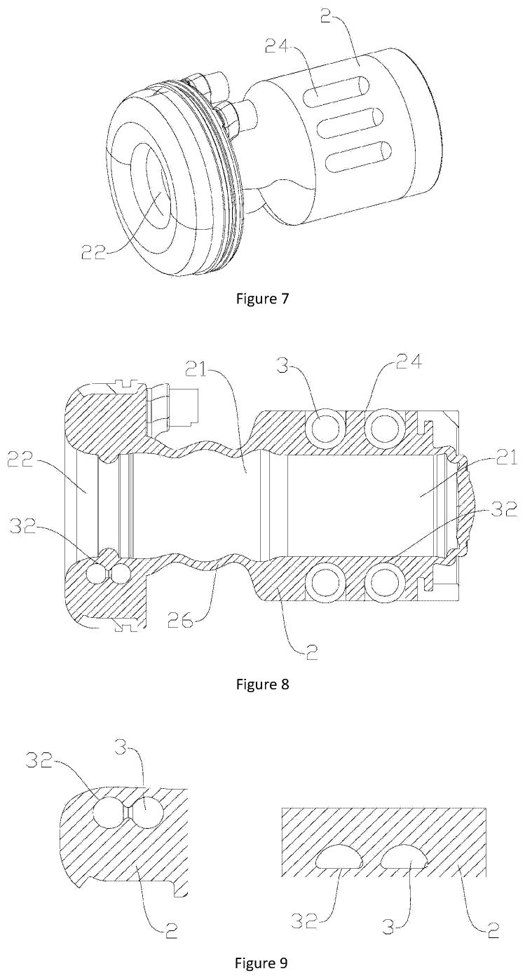

As shown in FIG. 7 and FIG. 8, in an embodiment, on an outer surface of the soft colloid 2 are provided the pressure expansion portions 3.

Preferably, the pressure expansion portions 3 are provided on an outer surface of the soft colloid 2.

Preferably, the pressure expansion portions 3 are buried on the outer surface of soft colloid 2.

On the outer surface of the soft colloids 2 are provided grooves 24, and the pressure expansion portions 3 are provided inside the grooves 24.

The grooves 24 can be provided along peripheral portions of the pressure expansion portions 3 or along axial directions of the pressure expansion portions 3.

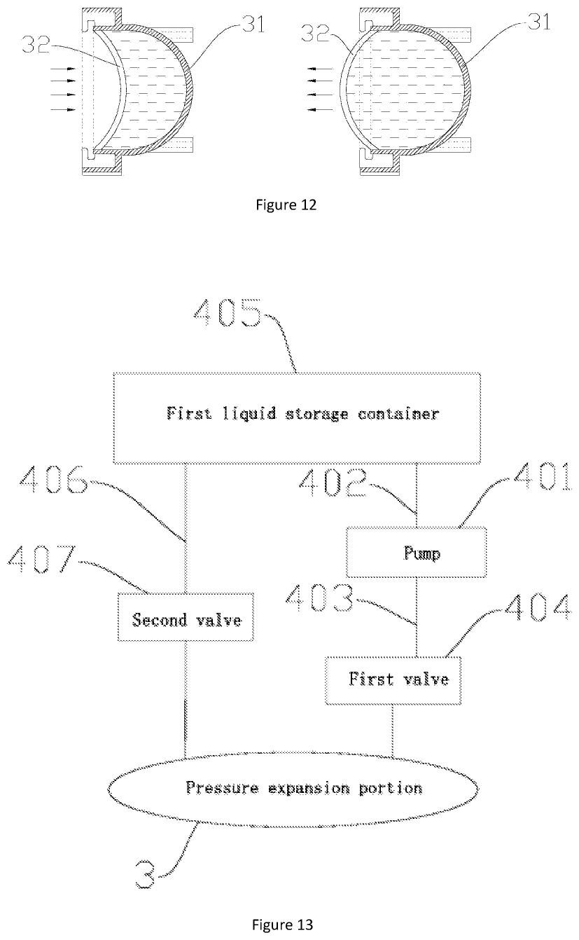

As shown in FIG. 11 and FIG. 12, the pressure expansion portions 3 provided at end portions of the soft colloid 2 back to the opening 22 of the massage channel is provided with a concave body 31, and the concave body 31 forms a shape of wrapping the opening 22 of the massage channel at end portions of the soft colloid 2 back to the opening of the massage channel 21.

End portions of the soft colloid 2 back to the opening 22 of the massage channel corresponds to head portions of the body parts and the concave body 31 forms a shape of wrapping the massage channel 21 back to the opening 22 of the massage channel; pressure of the pressure expansion portion 3 is adjusted by the pressure generating mechanism 4, when the concave body 31 is in a negative pressure state, the concave body 31 is depressed along a direction away from the soft colloid 2, when the concave body 31 is in a positive pressure state, the concave body 31 protrudes in a direction toward the soft colloid 2, so that the concave body 31 can be converted between convex and concave states, and the soft colloid 2 back to the opening of the massage channel can be converted between states when the pressure expansion portion 3 are under positive pressure and states when the pressure expansion portion 3 are under negative pressure.

As shown in FIG. 6, FIG. 8, FIG. 9 and FIG. 12, at sides of the pressure expansion portions 3 facing the massage channel are provided easily deformable walls 32, and the easily deformable walls 32 deform when the pressure generating mechanism 4 adjusts pressure of the pressure expansion portions 3, and deformation of the easily deformable walls 32 is greater than deformation of other walls on the pressure expansion portions 3, so as to better extrude the massage channel 21 of the soft colloid 2.

The pressure expansion portions 3 adopt liquid as an expansion medium.

As shown in FIG. 2 and FIG. 13, in an embodiment, the pressure generating mechanism 4 comprises pumps 401, first pipelines 402, second pipelines 403, first valves 404 and first liquid storage containers 405; the first pipelines 402 communicate between the pumps 401 and the first liquid storage containers 405, the second pipelines 403 communicate between the pumps 401 and the pressure expansion portions 3, and the first valves 404 are provided on the second pipelines 403, and the first valves 404 are used to control opening and closing of the second pipelines 403.

Pumps 401 extract the liquid in the first liquid storage containers 405 through the first pipelines 402, and then deliver the same through the second pipelines 403 to the pressure expansion portions 3, the pressure expansion portions 3 expand as an amount of the liquid inside increases, and extrude the soft colloid 2, so as to enable the massage channel 21 of the soft collide 2 to perform an extrusion function, thereby working out a penis and getting erection last longer; by controlling the amount of the liquid delivered to the pressure expansion portions 3, the pressure of soft colloid 2 can be freely controlled, so that the massage channel 21 of soft colloid 2 can exert different extrusion forces and enhance the user's comfort.

The pressure generating mechanism 4 further comprises third pipelines 406 and second valves 407, the third pipelines 406 communicate between the pressure expansion portions 3 and the first liquid storage containers 405, the second valves 407 are provided on the third pipelines 406 and the second valves 407 are used to control opening and closing of the third pipelines 406; and the liquid in the pressure expansion portion 3 can be delivered to the first liquid storage containers 405 through the third pipelines 406.

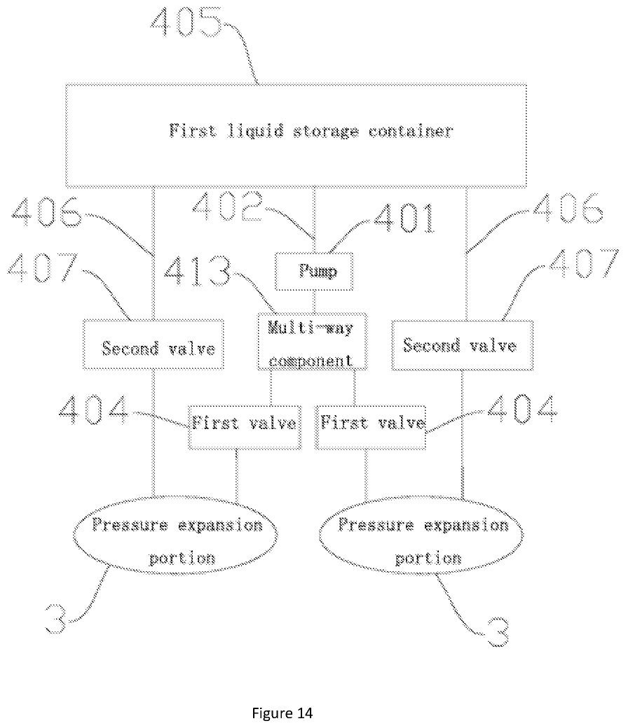

As shown in FIG. 13 and FIG. 14, preferably, at least two of the pressure expansion portions 3 are provided, and the second pipelines 403, the third pipelines 406 and the first valves 404 and the second valves 407 are provided corresponding to the pressure expansion portions 3, the second pipelines 403 communicate between the pumps 401 and the pressure expansion portions 3, the third pipelines 406 communicate between the first liquid storage containers 405 and the pressure expansion portions 3, the first valves 404 are provided on the second pipelines 403, the second valves 407 are provided on the third pipelines 406, and the pressure generating mechanism 4 further comprises multi-way components 413, the pumps 401 communicate with the second pipelines 403 through the multi-way components 413.

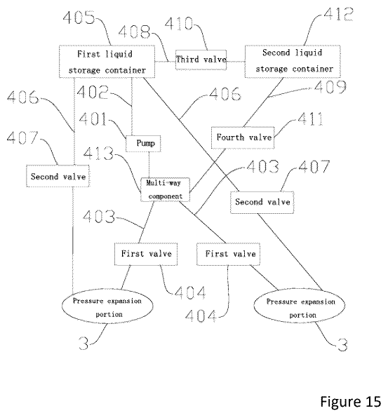

As shown in FIG. 15, the pressure generating mechanism 4 further comprises fourth pipelines 408, fifth pipelines 409, third valves 410, fourth valves 411 and second liquid storage containers 412; the fourth pipelines 408 communicate between the first liquid storage containers 405 and the second liquid storage containers 412, and the third valve 410 are provided on the fourth pipelines 408, the third valves 410 are used to control opening and closing of the fourth pipelines 408, the fifth pipelines 409 communicate between the second liquid storage containers 412 and the multi-way components 413, the fourth valves 411 are provided on the fifth pipelines 409, the fourth valves 411 are used to control opening and closing of the fifth pipelines 409.

The first liquid storage containers 405 are volume invariant containers, and the second liquid storage containers 412 are volume variable container;

when the second valves 407 are closed and the pumps 401 deliver liquid medium in the first liquid storage containers 405 or/and the second liquid storage containers 412 to the pressure expansion portions 3, a positive pressure field is formed inside and outside the pressure expansion portions 3; when the first valves 404 are closed and the pumps 401 deliver liquid medium in the pressure expansion portions 3 to the second liquid storage containers 412, a negative pressure field is formed inside and outside the pressure expansion portions 3; and the positive pressure field and the negative pressure field can be alternately converted.

Output end portions of the pumps 401 are provided with pressure sensors (not shown in the figures).

The first liquid storage containers 405 or the second liquid storage containers 412 are provided with temperature sensors (not shown in the figures), heating and/or cooling assemblies (not shown in the figures). The temperature sensors are used to sense temperature of the liquid in the first liquid storage containers 405 or the second liquid storage container 412, and the heating and/or cooling assembly can heat and/or cool the liquid to achieve the purpose of temperature regulation, and the pumps 401 deliver heated or cooled liquid to the pressure expansion portions 3, thereby further increasing users' comfort.

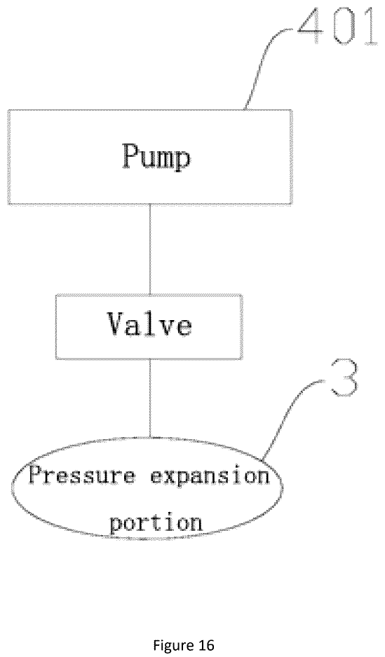

As shown in FIG. 16, in an embodiment, the pressure expansion portions 3 adopt gas as an expansion medium, the pressure generating mechanism 4 comprises pumps and pipelines, and the pipelines communicate with the pumps and the pressure expansion portions 3.

The pumps 401 pump the gas through the pipelines to the pressure expansion portions 3, and the pressure expansion portions 3 expand as an amount of the gas inside increases, and extrude the soft colloid 2, so that the massage channel 21 of the soft colloid 2 performs an extrusion function on body parts thereby working out a penis and getting erection last longer; by controlling the amount of the gas delivered to the pressure expansion portions 3, the pressure of soft colloid 2 can be freely controlled, so that the massage channel 21 of soft colloid 2 can exert different extrusion forces, thereby enhancing users' comfort.

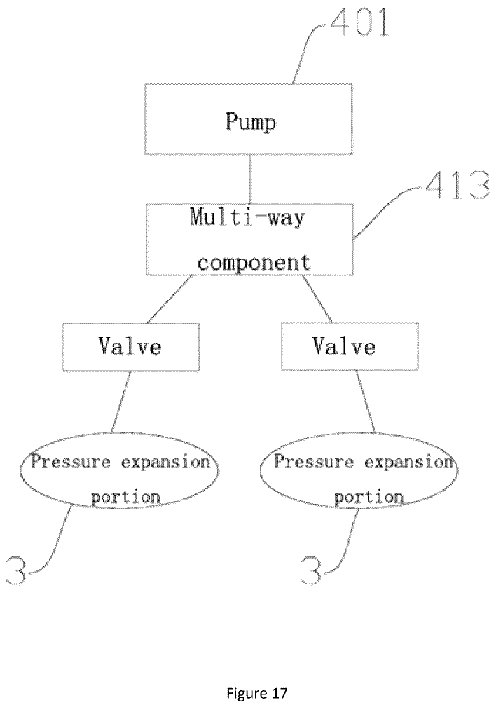

The pressure generating mechanism 4 further comprises valves, the valves are provided on the pipelines, and the valves are used to control opening and closing of the pipelines. As shown in FIG. 17, at least two of the pressure expansion portions 3 are provided, the pipelines and the valves are provided corresponding to the pressure expansion portions 3, the pressure generating mechanism 4 further comprises multi-way components 413, the pipelines communicate with the pumps and the pressure expansion portions 3, and the valves communicate with the pipelines through the multi-way components 413.

Output end portions of the pumps 401 are provided with pressure sensors.

As shown in FIG. 11, the soft colloid 2 is provided with wavy folds surrounding the massage channel 21 and the wavy folds 26 are provided to facilitate the expansion and contraction of soft colloid 2 along a direction of the massage channel 21.

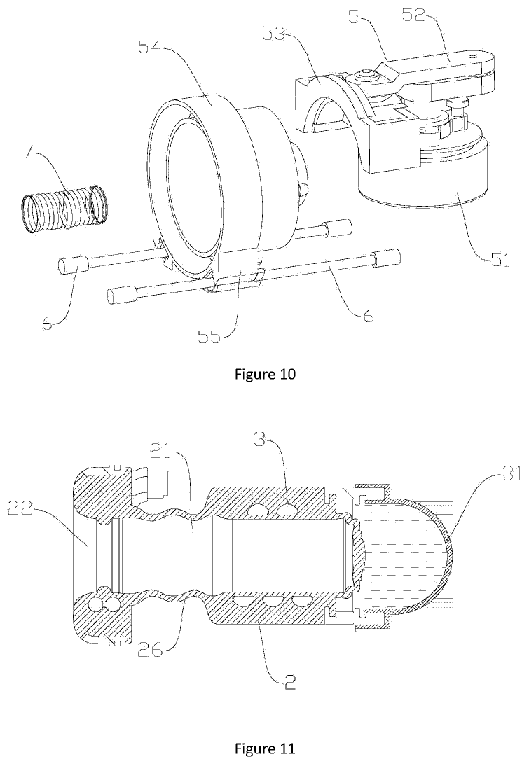

As shown in FIG. 1, FIG. 2 and FIG. 10, the physical therapy appliance further comprises a telescoping mechanism 5 provided inside the accommodating cavity 10, wherein the telescoping mechanism 5 connected to the soft colloids 2 is used to drive the soft colloid 2 to extend and retract.

The telescoping mechanism 5 comprises a drive assembly and a mobile portion 54, two end portions of the mobile portion 54 respectively connect to the drive assembly and the soft colloid 2, the drive assembly drives the mobile portion 54 to move inside the shell 1 and the soft colloid 2 is driven to extend and retract, so as to carry reciprocating motions, thereby rubbing and stimulating body parts.

The physical therapy appliance further comprises guide rails 6 provided inside the accommodating cavity 10, and the mobile portion 54 is provided with sliders 55 which are in sliding connection with the guide rails 6, and the mobile portion 54 is guided by sliders 55 on the guide rails 6.

In the present embodiment, the drive assembly comprises a motor 51, a connecting rod assembly 52 and a connecting member 53, the connecting rod assembly 52 is connected to an output end of the motor 51, and two end portions of the connecting member 53 respectively connect to the connecting rod assembly 52 and the mobile portion 54.

When the drive assembly works, the motor 51 drives the connecting rod assembly 52 to rotate, and the connecting rod assembly 52 drives the connecting member 53 to move in a direction towards or away from the mobile portion 54, so that, the mobile portion 54 are driven by the drive assembly to slide on the guide rails 6, and the soft colloid 2 is driven to extend and retract, so that the soft colloid can carry out reciprocating motions.

In other embodiments, the drive assembly may be a linear motor.

The physical therapy appliance further comprises a mounting base 8 provided inside the accommodating cavity 10 and the drive assembly is provided on the mounting base 8.

The physical therapy appliance further comprises an elastic member 7 provided inside the accommodating cavity 10, the elastic member 7 is connected with an end of the soft colloid 2 back to the massage channel opening 22.

The elastic member 7 is a spring or shrapnel, an end of the elastic member 7 is connected to the mobile portion 54, and another end of the elastic member 2 is connected to an end of the soft colloid 2 back to the opening 22 of the massage channel, so that the end of the soft colloid 2 back to the opening 22 of the massage channel can move towards the movable portion 54 through the elastic member 7, which can better suit different lengths of individuals, so the physiotherapy appliance can adapt to different length of individuals, improving experience of users.

The physical therapy appliance further comprises vibration mechanisms provided on the soft colloid 2 and used to control vibration of the soft colloid 2.

The vibration mechanism is a vibrating motor, which implements vibrating function of the physical therapy appliance, enhances the degree of stimulation to the massage site, and improves the comfort of the user.

An end of the soft colloid 2 near the opening 22 of the massage channel is provided with a positioning ring, and the shell 1 is provided with a ring buckle matching the positioning ring, and the positioning ring is engaged with the ring buckle.

The shell 1 is provided with a bottom cover 9, the bottom cover 9 is provided with internal threads, the shell 1 is provided with external threads, and the bottom cover 9 and the shell 1 can be screwed together. When the physical therapy device is not in use, the bottom cover 9 can be screwed onto the shell 1, which can play a protective role, prevent external dust from entering the massage channel 21, and prolong service life of the physical therapy device.

The physical therapy appliance further comprises a controller, and the controller is electrically connected with the pressure generating mechanism 4, pressure sensors, temperature sensors, a heating and/or cooling assembly and a vibration mechanism; and the pump 401, valve and pressure sensor, temperature sensor, heating and/or cooling components in pressure generation mechanism 4 are electrically connected to each other.

When the pressure generating mechanism 4 works, an amount of expansion medium delivered by the pump 401 to the pressure expansion portions 3 is controlled by the controller, so that the pressure of soft colloid 2 can be freely controlled, so that the massage channel 21 of soft colloid 2 can exert different extrusion forces, thereby enhancing user's comfort; the controller controls operation of the heating and/or cooling assembly to achieve heating and/or cooling of liquid in the first liquid storage container 405 or the second liquid storage container 412, and by sensing the temperature of the liquid in the first liquid storage container 405 or the second liquid storage container 412 to achieve the purpose of temperature regulation. The pump 401 delivers the heated or cooled liquid to the pressure expansion portion 3, further increasing users' comfort.

In the physiotherapy appliance provided by embodiments of the present invention, the drive assembly drives the mobile portion 54 to move inside the shell 1, and the soft colloid 2 is driven to extend and retract, so that the soft colloid can carry out reciprocating motions, thereby rubbing and stimulating body parts; an end of the elastic member 7 is connected with the mobile portion 54, and another end thereof is connected with the soft colloid 2 back to the opening 22 of the massage channel, and the soft colloid 2 back to the opening 22 of the massage channel can move toward the mobile portion 54 through the elastic member 7, in this way different lengths of individuals can be adapted to; by expansion of the pressure expansion portion 3, the massage channel 21 of soft colloid 2 has the effect of extrusion, and the effect of delaying erectile exercise can be realized, the pressure generating mechanism 4 is connected with the pressure expansion portion 3, and the pressure of the pressure expansion portion 3 can be adjusted through the pressure generating mechanism 4, so that the pressure of soft colloid 2 can be freely controlled, so that the massage channel 21 of the soft colloid 2 can obtain different extrusion forces, and can play a tight wrapping effect, so that soft colloid 2 has better friction and stimulation on the body parts thereby enhancing users' comfort, when the pressure expansion portions 3 adopt liquid as an expansion medium, the heating and/or cooling assembly heats or cools the liquid to achieve the purpose of adjusting temperature, and the pump 401 delivers heated or cooled liquid to the pressure expansion portions 3 to further enhance users' comfort; at middle portions of the massage channel 21 of the soft colloid 2 is provided at least one of the pressure expansion portions 3, which can be adapted to different diameters and different tightness and temperature requirements of individuals. End portions of the soft colloid 2 back to the opening 22 of the massage channel correspond to head portions of body parts an end portion of the soft colloid 2 back to the opening 22 of the massage channel forms a wrapping cavity, and at least one of pressure expansion portions 3 is provided at end portions of the soft colloid 2 facing back away from the opening 22 of the massage channel; the pressure generating mechanism 4 can adjust pressure of the soft colloid 2 and also can convert the pressure between positive and negative values to achieve functions of squeezing/sucking; and the physiotherapy appliance also comprises a vibration mechanism provided on the soft colloid 2 to implement vibration function of the physiotherapy appliance, so as to enhance degree of stimulation to body parts and improve comfort of users.

Obviously, the embodiments described above are only partial embodiments of the invention, but not all embodiments. The attached figure gives a better embodiment of the invention, but does not limit the protection scope of the present invention. The present invention may be realized in many different forms, but rather, these embodiments are provided for the purpose of providing a more complete understanding of the disclosure of the present invention. Although the present invention is described in details by reference to the above-mentioned embodiments, the technical solutions recorded in the above-mentioned specific embodiments may still be modified or some of the technical features may be replaced with equivalent effects for persons skilled in the art. Any equivalent structure made by using the specification of the present invention and contents of the attached drawings, and direct or indirect use of the present invention in other related technical fields, falls similarly within the protection scope of the present invention.

1. A physical therapy appliance, comprising:
a shell wherein inside the shell is provided an accommodating cavity;
a soft colloid wherein the soft colloid is provided with a massage channel, and at an end portion of the soft colloid is provided an opening of the massage channel;
pressure expansion portions wherein the pressure expansion portions are provided on the soft colloid; and
a pressure generating mechanism wherein the pressure generating mechanism is provided inside the accommodating cavity or on the shell, the pressure generating mechanism is connected to the pressure expansion portions and is configured to adjust pressure of the pressure expansion portions.

2. The physical therapy appliance according to claim 1, wherein the pressure expansion portions are provided at end portions of the soft colloid towards the opening of the massage channel to correspond to root portions of body parts, and/or middle portions of the massage channel to correspond to middle portions of body parts and/or end portions of the soft colloid back to the opening of the massage channel to correspond to head portions of body parts.

3. The physical therapy appliance according to claim 2, wherein on the soft colloid are opened expansion holes and the expansion holes are connected with the pressure generating mechanism to form the pressure expansion portions on the soft colloid; or
the soft colloid is provided with mounting pipelines, and the pressure expansion portions are provided inside the mounting pipelines.

4. The physical therapy appliance according to claim 2, wherein on an outer surface of the soft colloid are provided grooves, and the pressure expansion portions are provided inside the grooves.

5. The physical therapy appliance according to claim 2, wherein the pressure expansion portions provided at end portions of the soft colloid back to the opening of the massage channel comprise a concave body, and the concave body forms a shape of wrapping the massage channel at end portions of the soft colloid back to the opening of the massage channel.

6. The physical therapy appliance according to claim 1, wherein the pressure expansion portions are in shape of arcs, rings or spirals provided around the massage channel.

7. The physical therapy appliance according to claim 1, wherein at sides of the pressure expansion portions facing the massage channel are provided easily deformable walls, and the easily deformable walls deform when the pressure generating mechanism adjusts pressure of the pressure expansion portions, and deformation of the easily deformable walls is greater than deformation of other walls on the pressure expansion portions.

8. The physical therapy appliance according to claim 2, wherein the pressure expansion portions adopt a liquid as expansion medium, the pressure generating mechanism comprises pumps, first pipelines, second pipelines, first valves and first liquid storage containers; the first pipelines communicate between the pumps and the first liquid storage containers, the second pipelines communicate between the pumps and the pressure expansion portions, the first valves are provided on the second pipelines, and the first valves are used to control opening and closing of the second pipelines.

9. The physical therapy appliance according to claim 8, wherein the pressure generating mechanism further comprises third pipelines and second valves, the third pipelines communicate between the pressure expansion portions and the first liquid storage containers, the second valves are provided on the third pipelines, and the second valves are used to control opening and closing of the third pipelines.

10. The physical therapy appliance according to claim 9, wherein at least two of the pressure expansion portions are provided; the second pipelines, the third pipelines and the first valves and the second valves are provided corresponding to the pressure expansion portions; and the pressure generating mechanism further comprises multi-way components, and the pumps communicate with the second pipelines through the multi-way components.

11. The physical therapy appliance according to claim 10, wherein the pressure generating mechanism further comprises fourth pipelines, fifth pipelines, third valves, fourth valves and second liquid storage containers; the fourth pipelines communicate between the first liquid storage containers and the second liquid storage containers, the third valves are provided on the fourth pipelines, the third valves are used to control opening and closing of the fourth pipelines, the fifth pipelines communicate between the second liquid storage containers and the multi-way components, the fourth valves are provided on the fifth pipelines, the fourth valves are used to control opening and closing of the fifth pipelines.

12. The physical therapy appliance according to claim 11, wherein the first liquid storage containers are volume invariant containers, and the second liquid storage containers are volume variable container; when the second valves are closed and the pumps deliver the liquid medium in the first liquid storage containers or/and the second liquid storage containers to the pressure expansion portions, a positive pressure field is formed inside and outside the pressure expansion portions; when the first valves are closed and the pumps deliver the liquid medium in the pressure expansion portions to the second liquid storage containers, a negative pressure field is formed inside and outside the pressure expansion portions; and the positive pressure field and the negative pressure field can be alternately converted.

13. The physical therapy appliance according to claim 12, wherein the first liquid storage containers or the second liquid storage containers are provided with temperature sensors, heating and/or cooling assemblies.

14. The physical therapy appliance according to claim 8, wherein the pressure expansion portions adopt a gas as expansion medium, the pressure generating mechanism comprises pumps and pipelines, and the pipelines communicate between the pumps and the pressure expansion portions.

15. The physical therapy appliance according to claim 14, wherein the pressure generating mechanism further comprises valves, the valves are provided on the pipelines, and the valves are used to control opening and closing of the pipelines.

16. The physical therapy appliance according to claim 15, wherein at least two of the pressure expansion portions are provided; the pipelines and the valves are provided corresponding to the pressure expansion portions, the pressure generating mechanism further comprises multi-way components, the valves communicate with the pipelines through the multi-way components.

17. The physical therapy appliance according to claim 15, wherein output end portions of the pumps are provided with pressure sensors.

18. The physical therapy appliance according to claim 1, wherein the soft colloids are provided with wavy folds surrounding the massage channel.

19. The physical therapy appliance according to claim 1 further comprising a telescoping mechanism and a mounting base which are provided inside the accommodating cavity, wherein the telescoping mechanism is used to drive the soft colloid to extend and retract, the telescoping mechanism comprises a drive assembly and a mobile portion, the drive assembly is provided on the mounting base, and two end portions of the mobile portion respectively connect to the drive assembly and the soft colloid.

20. The physical therapy appliance according to claim 19, wherein the drive assembly comprises a motor, a connecting rod assembly and a connecting member, the connecting rod assembly is connected to an output end of the motor, two end portions of the connecting member respectively connect to the connecting rod assembly and the mobile portion; and the physical therapy appliance further comprises guide rails provided inside the accommodating cavity, and the mobile portion is provided with sliders which are in sliding connection with the guide rails.

21. The physical therapy appliance according to claim 19, wherein the physical therapy appliance further comprises an elastic member provided inside the accommodating cavity, an end of the elastic member is connected to the mobile portion, and another end of the elastic member is connected to an end of the soft colloid back to the opening of the massage channel.

22-25. (canceled)
